(19) United States
(12) Patent Application Publication
(10) Pub. No.: US 2009/0271374 A1
(43) Pub. Date: Oct. 29, 2009

(54) SOCIAL NETWORK POWERED QUERY REFINEMENT AND RECOMMENDATIONS

(75) Inventors: David S. Korn, Sunnyvale, CA (US); Donald E. Bradford, Acampo, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/111,309

(22) Filed: Apr. 29, 2008

(51) Int. Cl. G06F 17/30

(52) U.S. Cl. 707/3; 707/E17.108

(57) ABSTRACT

Embodiments of the present invention enhance the search experience of a user by looking at the search history of one or more buddies to provide search enhancements to the user. Examples of search enhancements include an annotation or graphic adjacent to a search result indicating the search result has been visited by one of the user's buddies. In another embodiment, the relevance score assigned to a search result is increased if the search result has been visited by a buddy. In another aspect, alternative queries from the buddies' search history may be suggested to the user during the search session.

### BACKGROUND

Computer users enter search terms into search engines to find information about various items (e.g., people, sports teams, cities, and companies) or in some case to locate specific objects (e.g. documents, emails, and web pages). The goal of the search engines is to provide the computer users with relevant search results. Internet search engines are a common example of search engines that receive search terms and return search results.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to using search histories from one or more buddies to provide more relevant search results and search enhancements that improve the searching experience for the user. In one embodiment, a user submits a search query and is presented with search results and a search enhancement. A search enhancement may be presented adjacent to individual search results and indicate that the search result has been visited by buddies in response to queries similar to the one submitted by the user. In another embodiment, search results visited by buddies are given more weight by the search engine when ranking results or are presented in a separate section of the search results. Buddy search history information may also be used to suggest alternative queries that are related to a query submitted by the user.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is an illustration showing an exemplary computing system architecture suitable for utilizing search information from buddies to enhance a users search experience, in accordance with an embodiment of the present invention;

FIG. 3 illustrates a manner in which relationships between the current query and buddies' queries are analyzed to determine whether search results are related to a query, in accordance with embodiments of the present invention;

FIG. 4 illustrates a method of determining whether a buddy query is related to a current query by categorizing the buddy query and current query, in accordance with embodiments of the present invention;

FIG. 5 illustrates a method of determining whether a buddy query is related to a current query, in accordance with embodiments of the present invention;

FIG. 6 illustrates an additional method of determining whether the current query is related to buddy queries within the buddies' search history, in accordance with embodiments of the present invention;

FIG. 7 illustrates a method of determining whether a current query is related to a search result within the search history by category, in accordance with embodiments of the present invention;

FIG. 8 illustrates a method of determining whether a search result within the search histories of buddies is related to a current query using keywords, in accordance with embodiments of the present invention;

FIG. 9 includes a flow diagram showing an exemplary method for providing search enhancements based in part on buddy search histories, in accordance with embodiments of the present invention;

FIG. 10 includes a flow diagram showing an exemplary method for improving search results using search history from one or more buddies, in accordance with embodiments of the present invention;

FIG. 11 includes an exemplary screen display showing a search input interface, in accordance with embodiments of the present invention; and

FIGS. 12-14 include an exemplary screen display showing search enhancements, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Overview

Embodiments of the present invention provide a system and method of using search histories from a group of buddies to provide an improved search experience for the user. A buddy is a person designated by a user. A user may designate a single buddy or a group of buddies whose search history will be used to improve the users search experience. The search histories of these buddies, including related queries and sites visited in response to the related queries, may be used to provide more relevant search results, search enhancements, or suggest alternative search queries drawn from the buddy search histories. In one embodiment, in response to submitting a current query, a user is presented with search results and a search enhancement. A search enhancement may be presented adjacent to individual search results and indicate that the search result has been visited by a buddy. In another embodiment, a search enhancement provides a list of search results that have been visited by buddies and are related to the current query. In another embodiment, related search queries drawn from the buddy search histories are suggested to the user.

Accordingly, in one embodiment of the invention, a computerized system containing a processor and a computer-storage media for enhancing a search session using buddy search history information is provided. The system includes a search engine that receives a query from a user and generates a plurality of search results that are responsive to the query. The system also includes a search enhancement component that receives information identifying one or more buddies, wherein a buddy is a person designated by the user. The search enhancement component also generates one or more search enhancements that are based on a plurality of buddy search histories associated with the one or more buddies, wherein the plurality of buddy search histories includes at least queries associated with the one or more buddies that submitted the queries and search results associated with the one or more buddies that interacted with the search results. The search enhancement component also causes the one or more search enhancements to be displayed with the plurality of search results.

In another aspect, an embodiment of the invention is one or more computer-storage media having computer-executable instructions embodied thereon for performing a method of providing search enhancements based in part on buddy search histories. The method includes receiving a search query from a user, retrieving a search history for one or more buddies designated by the user, and presenting one or more search enhancements to the user based on the search query and the search history.

A further embodiment of the present invention is directed to one or more computer-storage media having computer-executable instructions embodied thereon for performing a method of improving search results using search history information from one or more buddies. The method includes storing search history information associated with individual users, wherein the individual users may designate a privacy level for the search history information associated with the individual user. The method further includes receiving a search query from a user and receiving information indicating one or more search buddies associated with the user. The method also include displaying one or more additional search queries related to the search query and drawn from a subset of the search history information that is associated with the one or more search buddies, wherein the one or more additional search queries are selectable by the user. The method also includes displaying search results in conjunction with a search enhancement.

### Exemplary Operating Environment

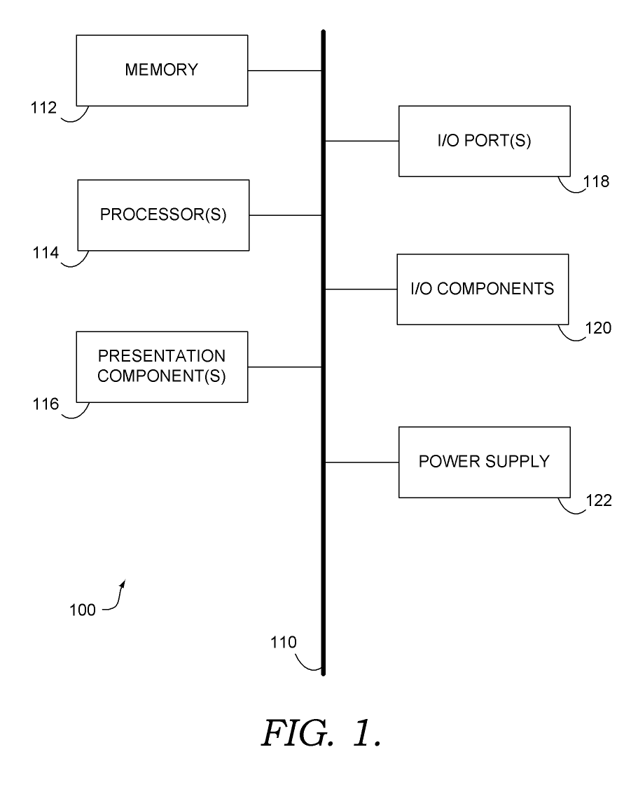

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary System Architecture

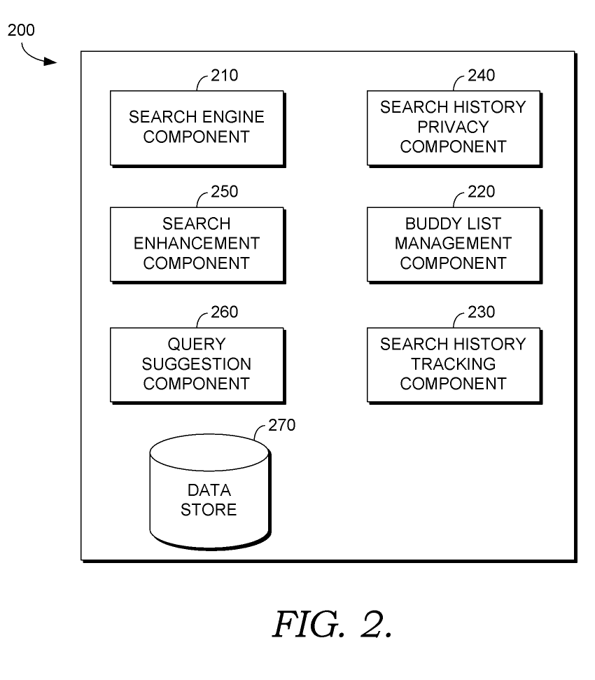

Turning now to FIG. 2, a block diagram is illustrated that shows a system architecture suitable for providing an enhanced search experience that utilizes search history information from one or more buddies. It will be understood and appreciated by those of ordinary skill in the art that the computing system architecture 200 shown in FIG. 2 is merely an example of one suitable computing system and is not intended to suggest any limitation as to the scope of the use or functionality of the present invention. Neither should the computing system architecture 200 be interpreted as having any dependency or requirement related to any single component/module or combination of component/modules illustrated therein.

Computing system architecture 200 includes a search engine component 210, a buddy list management component 220, a search history tracking component 230, a search history privacy component 240, a search enhancement component 250, a query suggestion component 260, and a data store 270. Computing system architecture 200 may reside on a single computing device, such as computing device 100 shown in FIG. 1. In the alternative, computing system architecture 200 may reside in a distributed computing environment that includes multiple computing devices coupled with one another via one or more networks. Such networks may include, without limitation, one or more local area networks (LANs) and/or one or more wide area networks (WANs). Such network environments are commonplace in offices, enterprise-wide computer networks, intranets, and the Internet. Accordingly, the network, or combination of networks, is not further described herein.

The search engine component 210 receives a search query and returns search results. In one embodiment, the search query is received over the Internet and the search results are web pages connected to the Internet. The search engine component 210 may include a web crawler that indexes web pages or other documents to aide in the process of quickly finding and presenting relevant search results. The search engine component 210 may apply an algorithm to determine which search results are the most relevant. The list of results produced or returned in response to a search query may be called the search engine results page or SERP.

Buddy list management component 220 performs several functions related to buddy lists, including creating, deleting, and storing buddy lists. A buddy list is a group of people designated by an individual user as buddies. A buddy list could be a user's contact list or a user's social network. In one embodiment, the individual users and people on the user's buddy list must all subscribe to or sign up for a search service. In one embodiment, the buddy list may be unilaterally established by a user. In other words, the people placed on the buddy list do not need to give consent to be added to a user's buddy list. In another embodiment, the buddy relationship is bilateral meaning that a person must consent to being placed on a user's buddy list.

The buddy list management component 220 may facilitate the creation of buddy lists. The buddy list management component 220 may allow users to edit the buddy list by adding buddies to and/or subtracting buddies from the list. The buddy list management component 220 may provide an interface to allow the user to input identification information (e.g. name, email address, user ID) for buddies. The buddy list management component 220 may also suggest buddies from a list for selection by the user. In a case where consent of a potential buddy is required to add them to a buddy list, the buddy list management component 220 may contact the potential buddy to obtain the necessary consent from the buddy.

The search history tracking component 230 facilitates the collection of search history information for individual users. The search history tracking component 230 may store search history by search contexts. A search context may include a query submitted by a user, the search results presented to the user in response to the query and those search results selected and viewed by the user in response to the query. The search results selected and viewed by the user may include more than just search results returned in the search engine result page (SERP). The search context information may include all content browsed from a search query. In addition, privacy information may be included in the search context that grants different levels of access to different users or buddies (as will be described in more detail below with reference to the search history privacy component 240). All of the information in an individual search context is associated with the user who submitted the search query. Several methods of identifying a user exist that allow the search history tracking component 230 to attribute the search context to the proper user. For example, an individual user may be identified by asking the user to login, enter an email address or entering some other identification information. In another embodiment, the user is identified by an IP address or through a cookie on the user's computer. In another embodiment, the search history information is collected by a client device that is used by the user during a search session. Thus, the client device may identify the user and send the search history information along with information identifying the user to a central data store. Other methods of identifying the user are also possible. In one embodiment, search history for a user is retrieved from a browser and used to populate the search history for the user. The retrieval of search history information from a browser may occur the first time the search history tracking component 230 interacts with a user, or as an ongoing way to collect search history information from the user.

An individual user may generate several search contexts during a search session. A search session starts when a user enters the search engine and stops when the user exits the search engine. A new search context may be generated every time a new query is submitted by the user. In one embodiment, the search history tracking component 230 facilitates storing search history information in data store 270.

The search history privacy component 240 collects privacy preferences and associates them with search contexts. In one embodiment, the search history privacy component 240 allows a user to designate a privacy level for each search context generated during a search session. In another embodiment, the user may designate a privacy level that is assigned to all search contexts generated during a search session. In another embodiment, a user selects a default privacy level that is assigned to all search contexts generated until the default privacy level is changed, or an individual privacy level is selected for a search session or a search context. The search history privacy component 240 may allow a user to designate a privacy level as a search query if submitted. The search history privacy component 240 may also allow a user to view their search history and assign or change the designated privacy level at any level of granularity. For example, the user could change the privacy level on a search context basis, a session context basis, or the entire search history.

The search history privacy component 240 may assign one of several privacy levels to a search history, or part of a search history. Different privacy levels may be designated for different parts of a user search history. In one embodiment, one of five different privacy levels are assigned to a user's search history or parts of the search history. The five privacy levels include a private designation, an individual buddies designation, an all buddies designation, a buddy group designation, and a public designation. The private designation indicates that the search context should not be shared with others or used in any way to enhance search results. The individual buddies designation indicates individual buddies that can use the search context to enhance a search. The all buddies designation indicates that all of the buddies on the users buddy list may use the search context to enhance a search. The buddy group designation indicates that one or more groups of buddies may use the search context to enhance a search. A public designation indicates that all users and buddies on a system may use the search context to enhance a search. The search history privacy component 240 may provide any number of interfaces to facilitate the collection of privacy level information.

The search enhancement component 250 provides search enhancements in response to a search query submitted by a user. The search enhancement utilizes search history information from one or more buddies of the user submitting the search query. In some embodiments, search history from all buddies included in the user's buddy list is used to provide search enhancements. An interface may be provided for the user to select an individual buddy, a group of buddies, a predefined group of buddies, or all buddies to provide a search enhancement. For example, a user could predefine a group of buddies consisting of hunting enthusiasts. When submitting a search query related to hunting, the user may wish to designate this predefined group to provide a search enhancement. The purpose of the search enhancement is to leverage the buddies' search experience to provide information regarding the relevance of search results presented to the user.

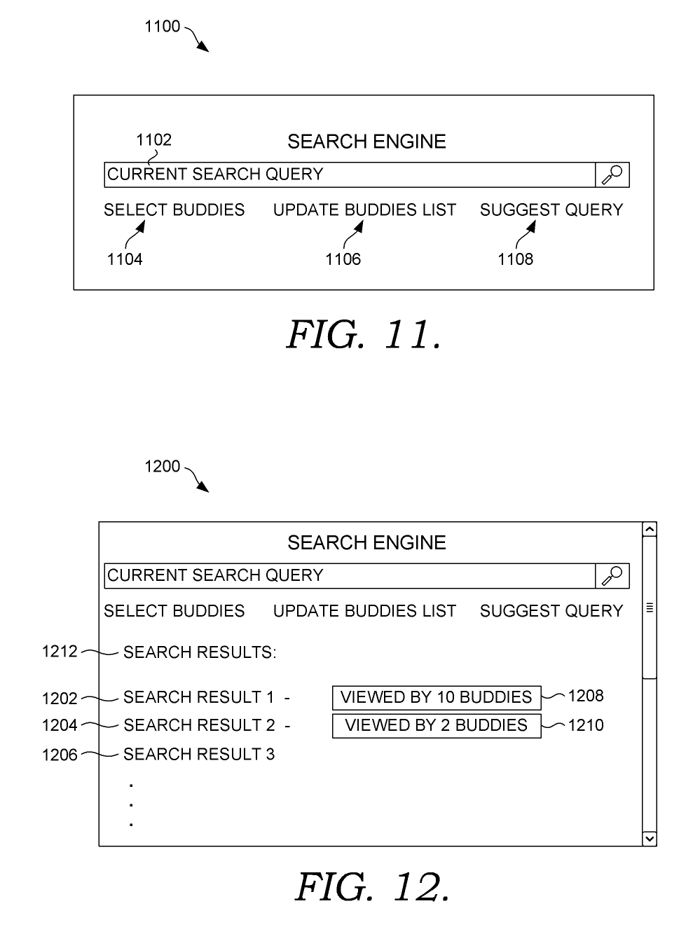

Many different kinds of search enhancements may be presented to a user. In one embodiment, the normal search results are presented in conjunction with a search enhancement that indicates an individual search result has been visited by a buddy. Normal search results are the search results returned by the search engine without taking the buddy search histories into account. The indication may list a specific buddy who selected and viewed a search result, the number of buddies that selected and viewed a search result, or just that at least one buddy selected and viewed a search result. In one embodiment, the search enhancement is a graphic that is displayed adjacent to an individual search result that is described by the graphic. FIGS. 11-14 illustrate various embodiments of a search enhancement. These embodiments are shown for the sake of example and are not meant to be limiting.

FIG. 11 depicts an illustrative screen display showing a search input interface 1100 that may be provided, for instance, via a search engine web page. The search input interface 1100 allows a user to input a current search query 1102. A user may select one or more buddies by selecting the select buddies link 1104. A user may update their buddy list by adding buddies to their buddy list and/or deleting buddies from their buddy list through the update buddies list link 1106. The user may solicit alternative queries that are related to the current query by selecting the suggest query link 1108. As described previously, the suggested queries could be taken from the search history of one or more buddies.

FIG. 12 depicts an illustrative screen display 1200 showing a search enhancement that indicates how many buddies have visited a particular search results. The search results section 1212 includes search result 1202, search result 1204, and search result 1206. In one embodiment, each of these search results is returned by the search engine without taking the buddy search history information into account. Search enhancement 1208 is displayed adjacent to search result 1202 and indicates that search result 1202 has been visited by 10 buddies. Search enhancement 1210 is displayed adjacent to search result 1204 and indicates that search result 1204 has been visited by two buddies. Notice that a search enhancement is not provided for search result 1206 illustrating that search results can be presented without a search enhancement.

In one embodiment, the normal search results (i.e. those returned without taking the buddies' search history into account) are re-ordered based on information from the search history, such as the number of times a search result has been selected and viewed by buddies. The re-ordered search results may be presented with or without other search enhancements. FIG. 12 shows search results 1202, 1204, and 1206 ordered according to the number of times they have been visited by one or more buddies. Search result 1202 is listed first because it has been visited by 10 buddies. Search result 1204 is listed second because it has been visited by two buddies. Search result 1206 is listed third because it has not been visited by any buddies. Search results, such as search result 1206, that have not been viewed by buddies may be ranked according to typical ranking mechanism used by the search engine.

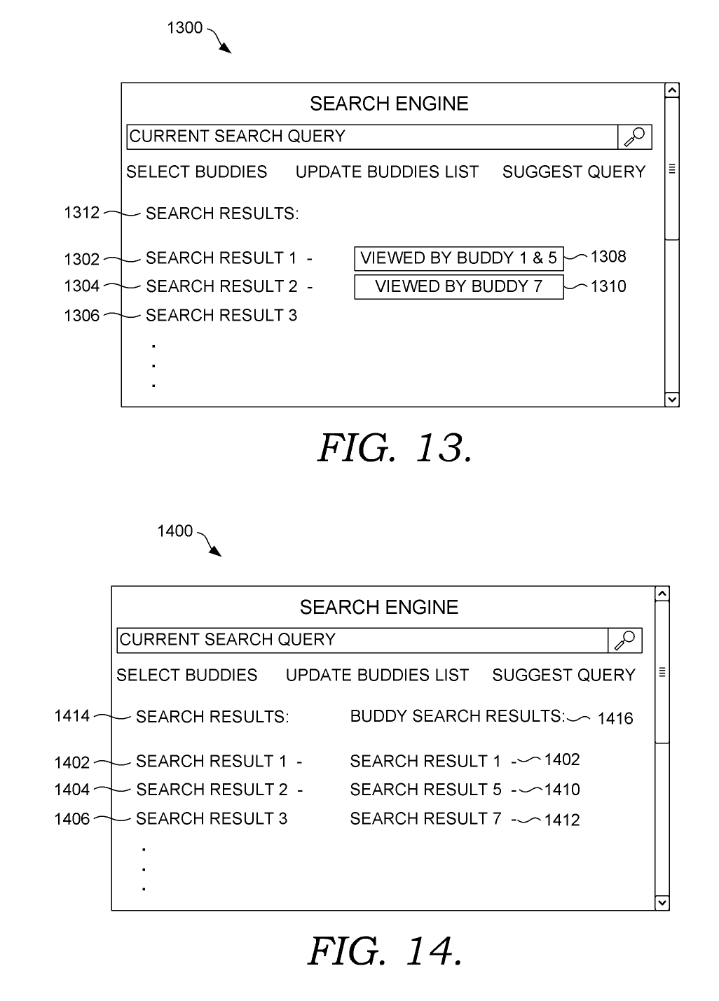

FIG. 13 depicts an illustrative screen display 1300 showing a search enhancement that indicates which buddies have visited a particular search result. The search results section 1312 includes search result 1302, search result 1304, and search result 1306. In one embodiment, each of these search results is returned by the search engine without taking the buddy search history information into account. Search enhancement 1308 is displayed adjacent to search result 1302 and indicates that search result 1302 has been visited by buddy 1 and buddy 5. Search enhancement 1310 is displayed adjacent to search result 1304 and indicates that search result 1304 has been visited by buddy 2. Notice that a search enhancement is not provided for search result 1206 illustrating that search results can be presented without a search enhancement.

FIG. 14 depicts an illustrative screen display 1400 showing a search enhancement that provides a separate section of search results that include results selected and visited by buddies. The search results section 1414 includes search result 1402, search result 1404, and search result 1406. In one embodiment, each of these search results is returned by the search engine without taking the buddy search history information into account. The buddy search results section 1416 displays one or more search results that are have been visited and selected by one or more buddies and are related to the current search query. The buddy search results section 1416 includes search result 1402, search result 1410, and search result 1412. Search result 1402 is listed in both sections indicating that a search result may appear in both sections if it meets the respective criteria for inclusion in each search result section.

When providing the search enhancement, the privacy level of search context information submitted by the buddies will be honored. For example, if a buddy has been designated by a first user, but does not have any search history available to the first user because of privacy levels assigned to the search history information then that buddy's search history information will not be used to provide a search enhancement. In some instances, the privacy level assigned to search information that appears in multiple contexts may be in conflict. A conflict in the search history information can occur when the same search result is viewed in response to two different queries because each query is part of a different search context and each search context may be assigned a different privacy level. For example, a search result visited in one context in response to a first query may be designated private, whereas the same search results visited in a second context in response to a second query may be designated as public. In one embodiment, the conflict is resolved by utilizing the search history information at the lowest privacy level. The lowest privacy level is the level that allows the most information to be used. In another embodiment, the conflict is resolved by ascribing the highest privacy level to the conflicting search history information. In the embodiment where the lowest privacy level is used, the search result will be used to enhance the buddies' search. For example, if in response to a query regarding cars, a buddy visits a consumer advocacy site and designates that search context containing the query and the consumer advocacy site as public and then visits the consumer advocacy site in response to a second query that is designated private, the consumer advocacy site would nevertheless be utilized by the search enhancement component 250 to generate a search enhancement. On the other hand, the opposite result will occur if the highest privacy level governs the conflict in privacy levels. In that case, the consumer advocacy site would not be utilized by the search enhancement component 250 to generate a search enhancement because it is part of a search context designed as private.

The search enhancement component 250 may provide other search enhancements such as reordering the search results based on giving more weight to search results viewed by one or more buddies. In another embodiment, a separate group of search results that have been visited by buddies and that are related to the submitted query are presented in a separate section. In yet another embodiment, the search enhancement includes interacting with the search engine to adjust the relevant weight given to search results visited by buddies.

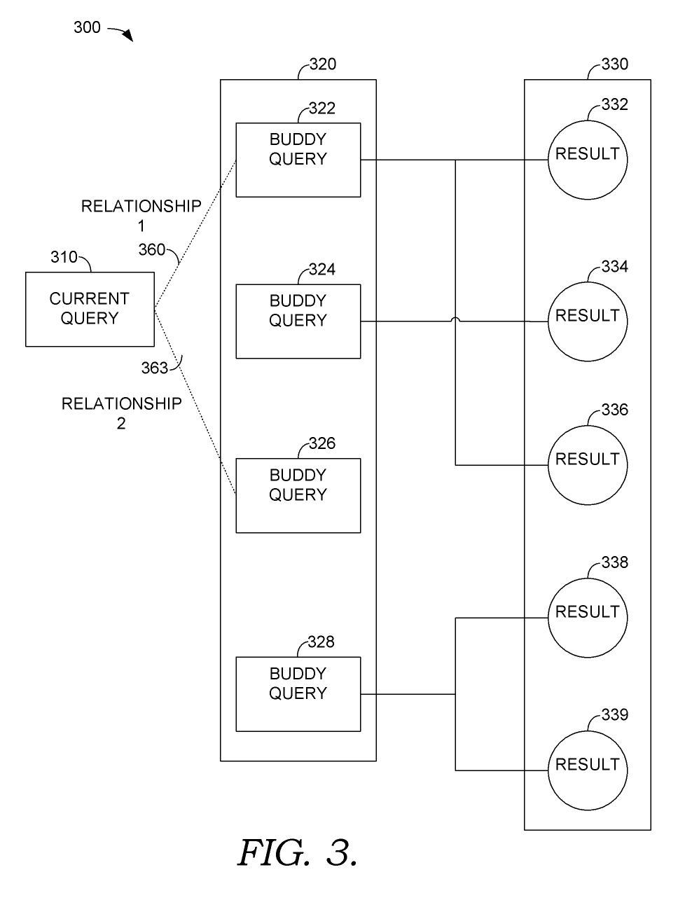

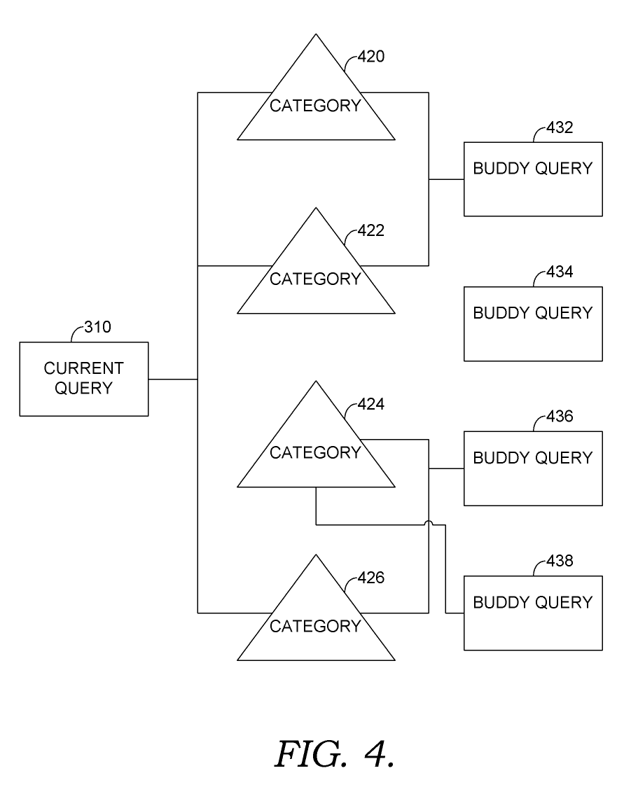

An important aspect of providing a search enhancement includes determining which search results and queries within a buddies' search history are related to the current query submitted by the user. FIG. 3 and FIGS. 7-8 illustrate determining whether a search result within the search history is related to the current query. FIGS. 4-6 illustrate determining whether a buddy query is related to the current query. The examples shown in FIGS. 3-8 are for the sake of illustration only, and are not meant to be limiting. Other methods of determining whether a relation ship exists between the current query and a buddy query or the current query and a buddy search result are possible.

FIG. 3 illustrates a manner in which relationships between the current query and buddies' queries from the search history are analyzed to determine whether search results are related to the current query in accordance with embodiments of the present invention. The analysis illustrated in FIG. 3 determines that a search result is related to a current query if the search result was selected and viewed by a designed buddy when the search result was presented in response to a buddy query that is related to the current query. FIG. 3 shows a current query 310 submitted by the user. FIG. 3 also shows a buddy query group 320 including a group of queries submitted by buddies, and buddy result group 330 including search results visited by the buddies in response to the various buddy queries. Buddy query group 320 and buddy search result group 330 are taken from the search histories for the user's buddies. Buddy query group 320 includes buddy query 322, buddy query 324, buddy query 326, and buddy query 328. Only four buddy queries are shown for the sake of illustration, but many more buddy queries could be includes. Buddy search result group 330 includes search result 332, search result 334, search result 336, search result 338, and search result 339. As with the buddy queries, the search results are taken from the buddies' search histories and could include many more search results than the five shown. Current query 310 is related to buddy query 322 through relationship 360. Buddy query 326 is related to current query 310 through relationship 362. The various methods of determining whether a relationship between the current query 310 and a buddy query are described subsequently. In one embodiment, search result 332 and search result 336 would be related to the current query 310 because they were visited by a buddy in response to buddy query 322 which is related to the current query 310. The search results visited only in response to buddy query 324 and buddy query 328 may not to be related to current query 310 since buddy query 324 and buddy query 328 are not related to the current query. Thus, in this embodiment, only search result 332 and search result 336 would be determined to be related to current query 310.

Turning now to FIG. 4, a block diagram illustrates determining whether a buddy query is related to a current query by categorizing the query, in accordance with embodiments of the present invention. In this embodiment, a buddy query is related to the current query 310 if it falls within one or more of the same categories. A category may be a designation assigned to a search result or query based on the subject matter of the search result or query. Both search results and queries may be assigned categories to help present relevant search results in response to a query. FIG. 4 includes current query 310 category 420, category 422, category 424, and category 426. The lines between the current query 310 and category 420, category 422 and category 426 indicate that the current query 310 is categorized into these three categories. The current query 310 does not fall into query category 424, as indicated by the lack of a connection. FIG. 4 also includes buddy query 432, buddy query 434, buddy query 436, and buddy query 438. Buddy query 432 is related to current query 310 because they have at least one category in common. In this case, they are both in category 420 and category 422. Buddy query 434 is not related to current query 310 because it is not related to category 420, category 422, or category 426. Buddy category 436 is related to current query 310 because they are both in category 426. In one embodiment, the fact that buddy query 436 is also categorized in category 424 which is not related to the current query 310 does not prevent it from being related to the current query 310. Buddy search query 438 is not related to the current query 310 because it is not related to one of the categories to which current query 310 is related.

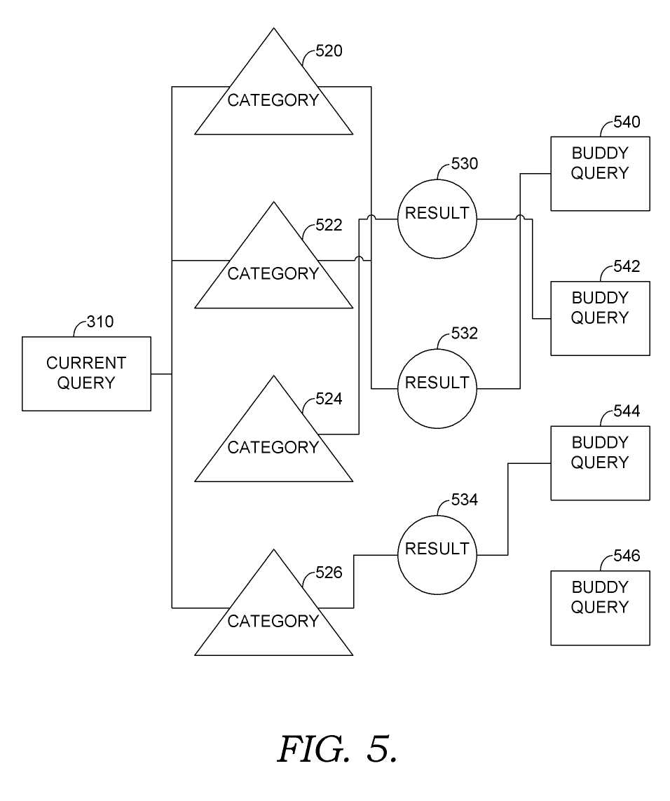

Turning now to FIG. 5, a block diagram illustrates determining whether a buddy query is related to a current query, in accordance with embodiments of the present invention. In this embodiment, buddy queries are determined to be related to the current query 310 if the buddy query produces at least one search result that is in the same category as the current query 310 and that was visited by at least one buddy in response to a buddy query. FIG. 5 includes current query 310. FIG. 5 also includes category 520, category 522, category 524, and category 526. FIG. 5 also shows search result 530, search result 532, and search result 534. In one embodiment, all search results within the search histories of buddies that fall within categories assigned to the current query 310 may be included in the evaluation. FIG. 5 also includes buddy query 540, buddy query 542, buddy query 544, and buddy query 546. The lines between the current query 310 and categories indicate that the current query 310 is categorized into the category to which it is connected. Thus, the current query 310 is categorized into categories 520, 522, and 526, but not category 524. The lines between search results and categories indicate that the search result is in the category or categories to which it is connected. Thus, search result 530 is in category 524, search result 532 is in category 520 and 522, and search result 534 is in category 526. The lines between search results and buddy queries indicate that the search result was visited by a buddy in response to the query to which the search result is connected. Thus, search result 530 was visited in response to buddy query 542, search result 532 was visited in response to buddy query 540, and search result 534 was visited in response to buddy query 544.

Continuing with FIG. 5, buddy queries are determined to be related to the current query 310 if the search results visited in response to the buddy query are in the same category as the current query 310. For example, buddy query 540 is related to the current query 310 because search result 532, which shares category 520 with current query 310, was visited in response to buddy query 540. Similarly, buddy query 544 is related to current query 310 because search result 534, which shares category 526 with current query 310, was visited in response to buddy query 544. Conversely, buddy query 542 is not related to current query 310 because search result 530 is only in category 524, which is not shared with current query 310. Buddy query 546 is unrelated to any of the search results and, thus, is not related to current query 310.

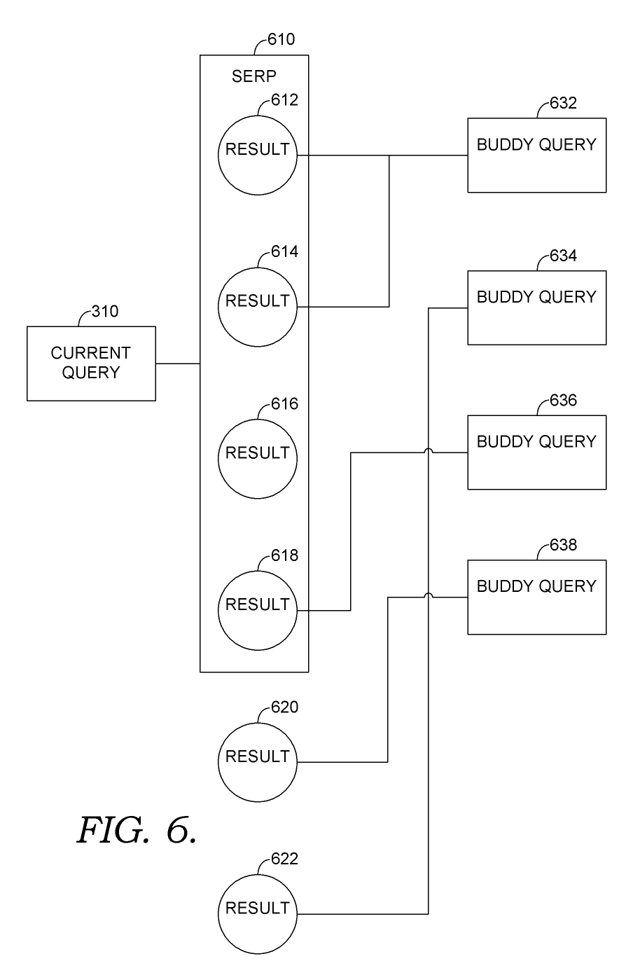

Turning now to FIG. 6, a block diagram illustrates determining whether the current query is related to buddy queries within the buddy search history, in accordance with an embodiment of the present invention. In this embodiment, buddies' queries are related to the current query 310 if they returned one or more search results that are also within the search engine results page (“SERP”) 610 for the current query 310. The SERP 610 includes search results returned by the current query 310 without use of the buddy search history information. FIG. 6 includes current query 310 and a group of search results within the SERP 610. The search results within SERP 610 include search result 612, search result 614, search result 616, and search result 618. Search result 620 and search result 622 are also shown but they are not within SERP 610. FIG. 6 also includes buddy query 632, buddy query 634, buddy query 636, and buddy query 638. The lines between buddy search query 632 and search results 612 and 614 indicate that search results 612 and 614 selected by a buddy in response to buddy query 632. The line between buddy search query 634 and search result 622 indicates that search result 622 was selected by a buddy in response to buddy query 634. The line between buddy search query 636 and search result 618 indicates that search result 618 was selected in response to buddy query 636. The line between buddy search query 638 and search result 620 indicates that search result 620 was selected in response to buddy query 638.

Continuing with FIG. 6, buddy query 632 is related to current query 310 because it resulted in the selection of search results 612 and 614, both of which are in the SERP 610. Similarly, buddy query 636 is related to current query 310 because it resulted in the selection of search result 618, which is in the SERP 610. Buddy query 634 and buddy query 638 are not related to current query 310 because search results within SERP 610 were not visited in response to either buddy query 634 or buddy query 638.

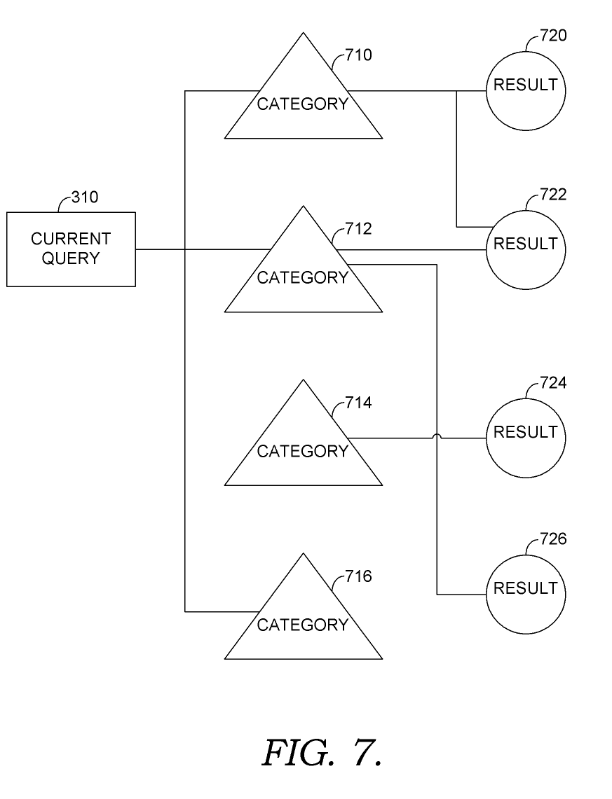

Turning now to FIG. 7, a block diagram illustrates determining whether a current query is related to a search result within the buddies' search history using categories, in accordance with an embodiment of the present invention. In FIG. 7, a buddy search result is related to the current query 310 if they have a category in common. FIG. 7 includes current query 310. Current query 310 falls into category 710, category 712 and category 716 as indicated by connecting lines. Current query 310 does not fall into category 714. Search result 720, search result 722, search result 724, and search result 726 are all found within the search histories of the user's buddies. Search result 720, search result 722, and search result 726 all fall into a category in common with the current query 310. Search result 724 falls under category 714, which is not related to current query 310. Accordingly, search result 724 is not related to the current query 310. Thus, only search result 720, search result 722, and search result 726 are related to the current query 310.

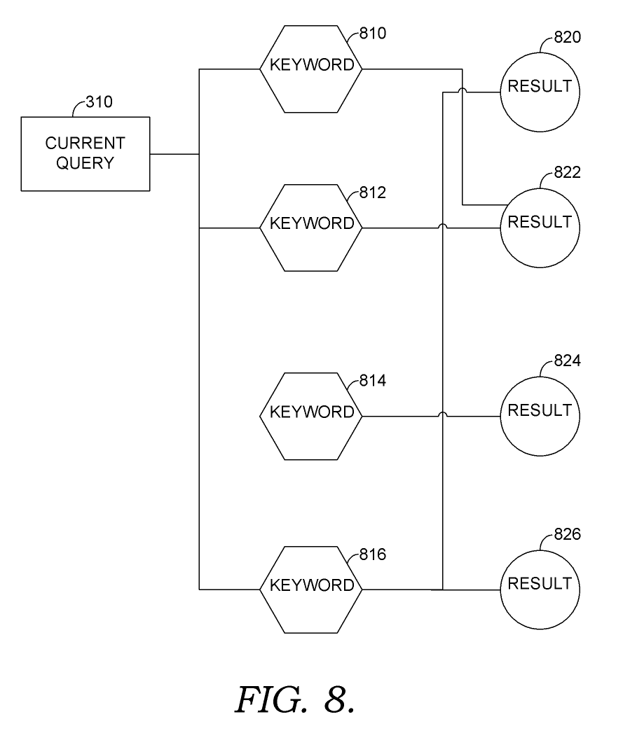

Turning now to FIG. 8, a block diagram illustrates determining whether a search result within the search histories of buddies are related to a current query using keywords, in accordance with embodiments of the present invention. Examples of keywords include a single word, multiple words, a clause, a sentence, numbers, and combinations of letters and numbers. In FIG. 8, the current query 310 is related to a buddy search result if they have a keyword in common. A keyword may be assigned to, or found within, a search result or query based on the subject matter of search result or query. In one embodiment, a list of keywords is assembled and assigned to a query or search result if the keyword occurs in the search result or query. FIG. 8 shows that current query 310 includes keyword 810, keyword 812, and keyword 816. Keyword 814 is shown for the sake of illustration but is not contained in current query 310. Search result 820, search result 822, search result 824, and search result 826 are all found within the search histories of buddies designated by the current user. Search result 820 is related to current query 310 because it also contains keyword 816. Search result 822 is related to the current query 310 because it contains keyword 810, and keyword 812. Search result 824 is not related to current query 310 because it is only related to keyword 814, which is not related to current query 310. Search result 826 is related to current query 310 because it contains keyword 816.

Returning now to FIG. 2, the search enhancement component 250 may utilize the methods of FIGS. 3-8, or other methods to determine that a search result within the buddy search history is related to the current query. In one embodiment, a search result from the search history information must also be in the SERP for the current query to be considered related. In other embodiments, the search result from the search history information does not need to be in the SERP for the current query. Having made this determination, search enhancements may be presented in association with the related search results as described previously.

The query suggestion component 260 identifies related queries within the buddy search histories and presents the related queries to the user as alternative query suggestions to allow the user to refine the search. The query suggestion component 260 may use the approaches described with reference to FIG. 3, FIG. 4, FIG. 5, FIG. 6, or another approach to determine whether a query within the buddy search history is related to the current query. Variations on the described methods as well as other methods not explicitly described may also be used. The query suggestions may be presented prior to presenting search results. The alternative query suggestions may also be presented after search results are presented.

Data store 270, may store information for the search engine, search histories, buddy lists, and any other information necessary to enable the functions of computer system architecture 200. In one embodiment, data store 270 organizes the information in a relational data base. Data store 270 may be centrally located and communicatively connected to other components operating on different computing devices.

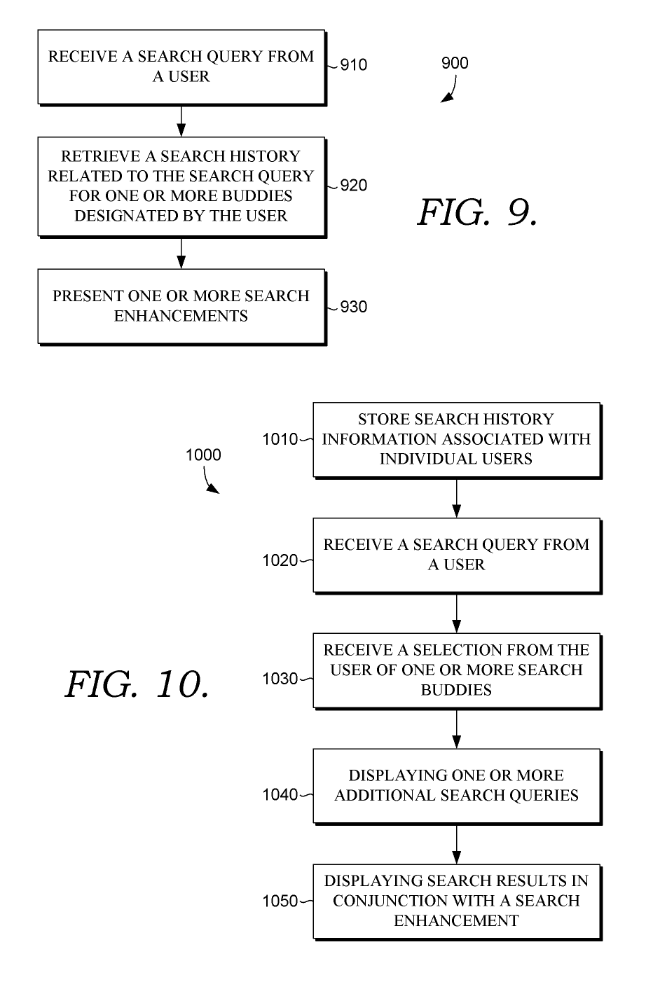

Referring next to FIG. 9, a flow diagram showing an exemplary method for providing search enhancements based in part on buddy search histories is shown and designated generally as reference numeral 900. At step 910, a search query is received from a user. In one embodiment, a search query is submitted over the Internet through a user interface intended to receive search queries. For example, a search query may be submitted in the query field present on an Internet web page. The query may be a single word, or a series of words. The query may also contain Boolean operators. Embodiments of the present invention are not intended to be limited by the type of query received or the manner in which the query is received.

At step 920, a search history for one or more buddies designated by the user is retrieved. In one embodiment, the buddies are designated through a user interface displayed to the user. In one embodiment, a single buddy is designated. In another embodiment, two or more buddies are designated. In another embodiment, a predetermined group of buddies is designated by the user. The buddies may be selected from a list of buddies that was previously created by the user. In another embodiment, the buddies may be entered in conjunction with the search query. In yet another embodiment, all buddies on a user's list may be used. A search history may be stored in a data store that is communicatively connected to the computing device retrieving the search history. As explained above, the search history may be stored in terms of search contexts that each includes a search query, search results visited by the buddy submitting the search query, and a privacy level. Other information may also be stored in a search context. Each individual search context should be associated with a single user making it possible to retrieve search histories for only one or more designated buddies.

At step 930, one or more search enhancements are presented to the user. The search enhancements are generated based in part on the search query and the retrieved search history. In one embodiment, a search enhancement includes an annotation displayed adjacent to an individual search result. As illustrated in FIG. 12, the annotation may communicate the number of buddies that have viewed the individual search result. As illustrated in FIG. 13, the annotation may identify one or more buddies that have actually viewed the search result. In yet another embodiment, the annotation may simply indicate that at least one buddy has viewed the individual search result. As illustrated in FIG. 14, the search enhancement may include a separate section of search results that have been viewed by one or more buddies and are related to the search query. Some methods of determining whether a search result is related to a current query have been described previously. In another embodiment, the search enhancement includes reordering the search results returned from the query by giving additional weight to search results with the SERP that were visited by a buddy. This ensures that search results visited by buddies will be considered more relevant than search results that have not been visited by buddies.

In one embodiment, one or more additional search queries related to the current search query may be presented to the user for selection as a query suggestion to refine the user's search. The additional queries may be drawn from the search histories of the one or more designated buddies if it is determined to be related to the originally submitted search query. Some methods of determining whether a query within the search histories of designated buddies is related to the current query have been described previously.

A privacy input interface may be presented to the user in conjunction with the search engine results page or any other time during a search session. The privacy input interface allows the user to select a privacy level for each search context associated with the user. As described previously, a search context may include an individual query, search results viewed by the user submitting the individual query, and privacy information. In one embodiment, privacy level information is received through the privacy input interface presented to the user. The privacy level information may then be stored in association with the search context in a data store that is used to store the search context information. Various privacy levels that may be used have been described previously.

Turning now to FIG. 10, a flow diagram showing an exemplary method for improving search results using search history information from one or more buddies is shown and designated generally with reference to numeral 1000. At step 1010, search history information associated with individual users is stored. The individual users may designate a privacy level for the search history information associated with the individual user. Methods of assigning privacy levels to various parts of a user's search history have been described previously as have various privacy levels.

At step 1020, a search query is received from a user. Various embodiments of receiving a search query for a user have been described previously with reference to FIG. 9. At step 1030, identification information for one or more search buddies associated with the user is received. At step 1040, one or more additional search queries related to the search query and drawn from a subset of the search history information that is associated with the buddies are displayed to the user. As described previously, the one or more search queries may be selected by the user. Upon selection of a related search query, results associated with that search query will be presented to the user. At step 1050, the search results normally returned from the original search query are presented in association with one or more search enhancements. Examples of possible search enhancements have been described previously with reference to FIGS. 11-14 and elsewhere.

### CONCLUSION

As can be understood, embodiments of the present invention provide an enhanced search experience using search history information from a group of one or more buddies. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computerized system containing a processor and a computer-storage media for enhancing a search session using buddy search history information, the system comprising:
a search engine that receives a query from a user and generates a plurality of search results that are responsive to the query; and
a search enhancement component that:
(1) receives identification information for one or more buddies, wherein a buddy is a person designated by the user,
(2) generates one or more search enhancements that are based on a plurality of buddy search histories associated with the one or more buddies, wherein the plurality of buddy search histories includes at least queries associated with the one or more buddies that submitted the queries and search results associated with the one or more buddies that interacted with the search results, and
(3) causes the one or more search enhancements to be displayed with the plurality of search results.

2. The computerized system of claim 1, wherein the one or more buddies includes one or more of a single buddy, a predefined group of buddies, all buddies on a buddy list, and a plurality of buddies individually selected during a search session, wherein the search session starts when the user accesses the search engine and ends when the user exits the search engine.

3. The computerized system of claim 1, wherein the one or more search enhancements includes an annotation displayed adjacent to an individual search result within the plurality of search results, wherein the annotation communicates information derived from the plurality of buddy search histories.

4. The computerized system of claim 3, wherein the annotation communicates one or more of: a number of buddies that have viewed the individual search result within the plurality of search results; an identification of individual buddies that have viewed the individual search result; and an indication that at least one buddy has viewed the individual search result.

5. The computerized system of claim 1, wherein the one or more search enhancements are displayed with the plurality of search results as a separate section of search results that are related to the query and that have been viewed by the one or more buddies.

6. The computerized system of claim 1, wherein the one or more search enhancements include reordering the search results to give more importance to individual search results that have been viewed by the one or more buddies.

7. The computerized system of claim 1, further comprising a query suggestion component that suggests a new query related to the query, wherein the new query is taken from the plurality of buddy search histories and determined to be related to the query.

8. The computerized system of claim 1, wherein the system further comprises a search history privacy component and a search history tracking component, wherein the search history privacy component allows the user and buddies to assign a privacy level to their search histories, and wherein the search history tracking component causes search history information to be stored.

9. One or more computer-storage media having computer-executable instructions embodied thereon for performing a method of providing search enhancements based in part on buddy search histories, the method comprising:
receiving a search query from a user;
retrieving a search history for one or more buddies designated by the user; and
presenting one or more search enhancements to the user based on the search query and the search history.

10. The one or more computer-storage media of claim 9, wherein the one or more search enhancements includes an annotation displayed adjacent to an individual search result, wherein the annotation communicates one or more of: a number of buddies that have viewed the individual search result; an identification of the one or more buddies that have viewed the individual search result; and an indication that at least one buddy has viewed the individual search result.

11. The one or more computer-storage media of claim 9, wherein the one or more search enhancements includes a separate section of results that have been viewed by the one or more buddies and are related to the search query.

12. The one or more computer-storage media of claim 9, wherein the one or more search enhancements include reordering the search results by giving additional weight to search results within the search history.

13. The one or more computer-storage media of claim 9, further comprising suggesting a new search query related to the search query based on the search history for the one or more buddies, wherein the new search query was submitted by one or more of the one or more buddies and determined to be related to the search query.

14. The one or more computer-storage media of claim 13, wherein the new search query is determined to be related to the search query if the search query and the new search query have above a threshold number of search results in common.

15. The one or more computer-storage media of claim 13, wherein the new search query is determined to be related to the search query if the search query and the new search query have a common search query category.

16. The one or more computer-storage media of claim 9, wherein the method further comprises:
presenting a privacy input interface to the user that allows the user to select a privacy level for a search context associated with the user, wherein the search context includes an individual query, search results returned in response the individual query, and search results viewed by a person submitting the individual query; and
receiving the privacy level designated by the user.

17. The media of claim 16, wherein the privacy level includes one or more of the following privacy level designations:
a private designation that indicates the search context should not be shared with others or used to refine suggestions for other buddies;
an individual buddies designation that indicates individual buddies that can use and view the search context;
an all buddies designation that indicates that all of the buddies may use and view the search context;
a buddy group designation that indicates one or more groups of buddies that may use and view the search context; and
a public designation indicating that all users on a system may use and view the search context.

18. One or more computer-storage media having computer-executable instructions embodied thereon for performing a method of improving search results using search history information from one or more buddies, the method comprising:
storing search history information associated with individual users, wherein the individual users may designate a privacy level for the search history information associated with the individual user;
receiving a search query from a user;
receiving information indicating one or more search buddies associated with the user;
displaying one or more additional search queries related to the search query and drawn from a subset of the search history information that is associated with the one or more search buddies, wherein the one or more additional search queries are selectable by the user; and
displaying search results in conjunction with a search enhancement.

19. The one or more computer-storage media of claim 18, wherein the search enhancement includes an annotation displayed adjacent to an individual search result within the subset of the plurality of normal search results, wherein the annotation communicates one or more of: a number of buddies that have viewed the individual search result; an identification of the one or more buddies that have viewed the individual search result; and an indication that at least one buddy has viewed the individual search result.

20. One or more computer-storage media of claim 18, wherein the search enhancement includes a separate section of results that have been viewed by the one or more buddies.
